(19) United States
(12) Patent Application Publication
(10) Pub. No.: US 2009/0198632 A1
(43) Pub. Date: Aug. 6, 2009

(54) SYSTEMS AND METHODS FOR INVESTMENT PORTFOLIO WITH FRACTIONAL AND VIRTUAL SHARES

(76) Inventor: James M. DILLAHUNTY, San Marcos, CA (US)

Correspondence Address: WILMERHALE/DC, 1875 PENNSYLVANIA AVE., NW, WASHINGTON, DC, 20006, US

(21) Appl. No.: 12/358,592

(22) Filed: Jan. 23, 2009

Related U.S. Application Data
(60) Provisional application No. 61/025,193, filed on Jan. 31, 2008.

(51) Int. Cl. G06Q 40/00

(52) U.S. Cl. 705/36 R

(57) ABSTRACT

Embodiments of the invention include a method for investor directed allocation of funds among a plurality of investments. The method includes allocating an investor's funds among investments according to a predefined allocation plan. An order processing system receives information from a reservoir of investments relating to the investments in the reservoir. An investor's order is executed by using an investment from a reservoir of investment vehicles. The investor's order is also executed by receiving an investment vehicle from a financial marketplace. The investment vehicle is received in response to a request by the order processing system to purchase at least one investment not available in the reservoir. This order execution is done at the time the investor's order for allocating of funds is received. The investment received from the reservoir and the investment purchased from the financial marketplace are combined to execute the investor's order.

### CROSS-REFERENCE TO RELATED APPLICATIONS

This application claims the benefit under 35 U.S.C. 119(e) of U.S. Provisional Patent Application No. 61/025,193, filed on Jan. 31, 2008 entitled “COMPUTER IMPLEMENTED SYSTEM AND METHOD FOR STRATEGIC ASSETS, INCOME AND RESERVES”, which is hereby incorporated by reference herein in its entirety.

### BACKGROUND OF THE INVENTION

1. Field of the invention

The invention relates generally to allocating an investor's investment funds to a selected or constructed portfolio of investments using fractional and/or virtual shares. More specifically, the invention relates to allocating the funds to the portfolio of investments using a reservoir of investments and just in time purchase of investments.

2. Description of the related Art

Many investors, by the time they reach their peak earning and peak investing ages (typically between 40-60 years of age) will have accumulated a variety of investments acquired as the opportunities arose, on an impulse, or as investable funds became available. Moreover the accumulation of assets frequently occurs with a number of Broker-Dealers and may not represent either disciplined investment practices, or the accumulation of strategically coordinated assets. Such a portfolio acquired over several years will likely consist of any combination of fixed maturity (Bonds, UITs, Options, Structured products, Mortgage backed Securities, Collateralized Debt obligations, etc.) and non-fixed maturity asset classes (Mutual Funds, Hedge Funds, Money market Accounts, Managed Accounts, Various Equities, Insurance Policies, Annuities, Limited Partnership Units, and Exchange Traded Funds, etc.).

Making investment purchases opportunistically, periodically in small amounts, or as funds become available does not lend itself to investors receiving either quantity discounts or fractional interests in attractively priced large blocks. As a result investors who accumulate even large portfolios over long periods of time; a.) Pay higher fees b.) Cannot access large block discounts and, c.) End up with assets in a number of brokerage accounts that are not strategically coordinated to reflect either short term or long term investment objectives or risk tolerance.

FolioFN is system for allowing investors to strategically make small or periodic investments. FolioFN restricts investors to buying and selling stocks, although either whole or fractional shares can be traded. FolioFN also limited the buying and selling to two trading windows a day. What is needed is a more comprehensive system allowing investors to invest in a wide variety of asset types, and to own fractional or virtual shares in those asset types.

### SUMMARY OF THE INVENTION

Embodiments of the invention include systems and methods for allocating an investor's investment funds to a selected or constructed portfolio of investments using fractional and/or virtual shares. More specifically, the invention relates to allocating the funds to the portfolio of investments using a reservoir of investments and just in time purchase of investments. Embodiments of the invention include a computer implemented method for investor directed allocation of funds among a plurality of investments. The method includes a server receiving, from an investor using a client computer system and through an electronic network, an order allocating the investor's funds among a plurality of investments according to a predefined allocation plan. The method further includes processing the order in an order processing system executing on the server, wherein the order processing system receives information from a reservoir of investments relating to what investments are in the reservoir, and wherein the reservoir is stored in an investment database accessible to the order processing system through an electronic network. The method includes executing the investor's order by receiving, in response to a request by the order processing system for an investment needed to execute the investor's order, at least one investment from the reservoir of investment vehicles. The investor's order is also executed by receiving at least one investment vehicle from a financial marketplace through a trading system coupled to the order processing system through an electronic network, wherein the investment vehicle is received in response to a request by the order processing system to purchase at least one investment not available in the reservoir, and wherein the request is made at the time the investor's order for allocating of funds is received. The method further includes combining the investment received from the reservoir and the investment purchased from the financial marketplace to execute the investor's order. The method further includes updating an account of the investor within the order processing system in response to the executed order. The method further includes generating a report based on the processing of the order and displaying to the investor, through a graphical user interface of the client computer system, the generated report.

Embodiments of the invention also include automatically replenishing the reservoir by a reservoir management system after an order is executed. This can be based on current or future orders. Embodiments of the invention also include pooling at least a portion of the investor's funds with other funds to purchase at least one investment vehicle. Embodiments of the invention also include where the predefined allocation plan is one of a standard allocation plan offered by the order processing system, and an allocation plan individually selected by the investor prior to the order.

Embodiments of the invention also include where the reservoir contains virtual investment vehicles, and wherein a virtual share is allocated to an investor to execute their order. Embodiments of the invention also include where, in response to a request by the order processing system for an investment needed to execute the investor's order, at least one investment from the reservoir of investment vehicles is a fractional portion of an investment, and the reservoir tracks the unused portion of the investment. Embodiments of the invention also include the ability to invest in investments made of subcomponents, with the order processing system automatically fulfilling the investor's order with respect to at least one sub-component in the same manner as it fulfills an order for an investment without sub-components.

### BRIEF DESCRIPTION OF THE DRAWINGS

Various objects, features, and advantages of the present invention can be more fully appreciated with reference to the following detailed description of the invention when considered in connection with the following drawings, in which like reference numerals identify like elements.

FIG. 1A is a block diagram showing the first part of the overall design of the STAIRS system.

FIG. 1B is a block diagram showing the second part of the overall design of the STAIRS system.

FIG. 2 is a block diagram showing the hardware design of the STAIR system.

FIG. 3 is a block diagram showing the software design of the STAIR system.

FIG. 4 is a diagram showing assembly of an investment from sub-assemblies sub-components.

FIG. 5A is a flow diagram showing the first part of the overall investment process using STAIR.

FIG. 5B is a flow diagram showing the second part of the overall investment process using STAIR.

FIG. 6 is a flow diagram showing further details of the order execution using a reservoir and just in time purchases.

### DETAILED DESCRIPTION OF EMBODIMENTS OF THE INVENTION

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the invention be regarded as including equivalent constructions to those described herein insofar as they do not depart from the spirit and scope of the present invention.

In addition, features illustrated or described as part of one embodiment can be used on other embodiments to yield a still further embodiment. Additionally, certain features may be interchanged with similar devices or features not mentioned yet which perform the same or similar functions. It is therefore intended that such modifications and variations are included within the totality of the present invention.

The STAIRs (Strategic Assets Income and Reserves) concept of investing is designed to allow investors to virtually and/or fractionally (aka fractional or whole) possess interests in the benefits and liabilities of a plethora of investment products and services, even if those services and products do not yet exist at the time of this application.

The STAIR account represents a single investment system that offers investors several unique options. First is the ability to acquire fractional and/or virtual interests in a variety of professionally prepared portfolios and a variety of asset classes. Second, investors can design and build their own custom portfolios using a broad array of assets. Third, STAIR, through its aggregation of funds, its market relationships, and influences, facilitates investors obtaining block prices for even small investment amounts. Fourth, subsequent investor contributions to a STAIR account can replicate and follow the dispersal patterns of previously established portfolios. All four of these desirable investment capabilities can, under the STAIR account, be acquired by making either periodic or one-time contributions to the STAIR account.

STAIR customers can place orders, build portfolios, and access their STAIR account directly over the Internet using publicly accessible Internet browsers, such as Internet Explorer, Google, Yahoo, Firefox or others. Investors can also access the offerings and services of STAIR through their Financial Advisor or an automated voice response system. The portfolios available through a STAIR account can incorporate both fixed maturity (i.e. bonds, for example) and non fixed maturity assets (Mutual Funds, or Managed Money accounts for example).

Through the STAIR processes, a small investor, with a diffuse pattern of investment allocations, would enjoy the same access to, risks, and returns which are in many instances available only to large or institutional accounts. STAIR acts as an aggregator of investor funds and together with STAIR's own capital, relationships, and influences in the marketplace can negotiate price and access to a broad array of investment opportunities. STAIR clients may make their investments in cash or may also elect to deposit other assets including closely held stock, or other securities and investments. Since STAIR products and services are designed to be easily accessed through standard internet web browsers, it is easy for investors to benefit from; a.) The vast amounts of computing power available in desk top PCs. b.) The functionality of the internet. c.) Sophisticated yet easy to use, financial allocation and modeling algorithms existing in the marketplace.

STAIR maintains a reservoir of various investment products, services, contracts, and relationships in which investors can purchase virtual interests in assets and thereby receive both the benefits and risks associated with each asset. The reservoir may contain physical or virtual inventory of fixed and non-fixed maturity assets, options contracts, and contracts for delivery of assets. The STAIR reservoir concept can easily accommodate investment products that the marketplace creates anew. STAIR can delete, and replenish the assets in the reservoir to meet anticipated and actual customer interests and needs.

The STAIR reservoir concept can be analogized to the cooking processes. As a food order is given to the chef it is completed through a series of preparation steps and standing recipes. The recipes require the chef to source materials from a common reservoir to prepare a variety of unique components of the entree. For example the chef may access the flour reservoir to prepare bread, and use the same flour reservoir in the preparation of, sauces, and again for a desert item. In the STAIR analogy flour would be represented by a single CUSIP or security that can be used as a Sub-Component to build a variety of Investments or portfolios

In one embodiment of STAIR (virtual shares the investment attributes (risk and rewards) are merely virtually assigned to the investor for a time period without being removed from the reservoir. The time period of an investor's virtual interests could be temporary, or last until the asset matures. In effect, investors are only renting the benefits and liabilities of the asset. Virtual shares allow an investor to own a portion of an investment, especially one that is not easily divided (e.g. a hedge fund account). Virtual shares also allow an investor to own a portion of large investment that required pooling of funds with other investors. Each investor can be assigned a virtual shares (or a number of virtual shares) proportional to the amount of funds they contributed.

In another embodiment of STAIR (fractional shares), either an entire Sub-Component, or a fractional amount of the Sub-Component is placed into an investor's portfolio, with the corresponding amount removed from the reservoir. In this way, the investor is the owner of that fractional part and has all the rights (or fractional proportion) associated with that investment. Fractional shares can be used with many types of investments, including investments that are easily divided, such as stocks, where ownership and other rights can also be easily divided. Fractional shares can also be used with investments where an investor maintains control over trading and management of the investment. An investor may choose not to sell an investment when it reaches maturity, or manage the investment in a way inconsistent with the other fractional owners.

STAIR can also make just-in-time purchases of investments to execute an investor's order. The just-in-time inventory management of STAIR can be compared to a manufacturing assembly line. In assembly line processes, once an order is received the availability of all the various component parts that make up the final product must be identified and brought together for assembly. If parts are not in inventory, they must be ordered and delivered just-in-time. Sub-Assemblies may be composed of many identical elements, such as transistors, etc. In STAIR, a single $10,000 bond CUSIP, (by virtual assignment of proportional ownership), can lend its investment attributes (Coupon, rating, maturity, etc.) to a number of different portfolios, and in turn to a number of different investors until it is 100% allocated or used up.

An other analogy that lends itself to understanding how STAIR portfolios are constructed can be demonstrated by examining how some computer retailers design in flexibility for customers buying PCs online. The online orders received by computer retailers are frequently processed using just-in-time inventory management. These retailers typically offer several different standard computer systems, for example, notebooks, desktops, printers, accessories, etc on their internet store fronts. In this analogy, when a customer selects “notebook computers,” they are transferred to a page illustrating offers of several pre-configured notebooks, and the option to custom build or custom modify each configuration. In effect, the final PC ordered by the customer is built at the time the order is received from a reservoir of in-house parts, or from parts delivered by suppliers, just-in-time. STAIR, can utilize similar “just-in-time” inventory management and portfolio construction techniques, and not actually create an investment portfolio or the Sub-Components that make up a portfolio, until there is an investor order. As a result STAIR customers may experience a delay between the time their order is placed, and when any “out-of-stock” Sub-Components are received by STAIR, assembled into the proper portfolio form, and delivered (possibly virtually) into the investor's account.

STAIR brings to investors:

Fractional and virtual ownership in specific identifiable assets and professionally constructed and/or custom made portfolios that include both fixed maturity, and non fixed maturity asset classes.

Cost efficient investing by virtue of aggregation of orders to obtain break point pricing and access to large blocks

Convenience of investment according to a periodic schedule (i.e. monthly or quarterly, etc.), or at will

Investor contributions can be allocated to customers' pre-existing STAIR portfolio profiles

Buy on demand, liquidate on demand, a designated asset (subject to restrictions)

STAIR can provide a level playing field serving the interests of large and small investors alike. For example, a small investment contribution to a STAIR account of $750 per month could, through the fractional and virtual ownership provided by STAIR, have funds distributed (diffused into, permeated into, investments) as follows; $200 in any of several pre-configured fixed income portfolios, $100 into a Mutual Fund (s), $150 into a Money Market Account(s), $200 into a Hedge fund(s), and $100 placed with a Money Manager. Similarly larger contributions can, through a single investment decision, be dispersed into a number of individual assets and portfolios. Because of the virtual nature of the STAIR concept, subsequent investment contributions can be allocated to the same portfolio profiles as the investor originally selected can conform to established strategic investment objectives, or new investment schema can be developed as subsequent investor contributions are made.

Embodiments of the STAIR invention allow an investor to strategically invest in a variety of investments Embodiments of the invention utilize a reservoir of investments to process an investor's order. Investments from the reservoir can be provided to execute all or part of an investor's order. The investments from the reservoir can fulfill a portion of the investor's order alone, or they can be combined with other investor's funds, other investor's orders, or just in time created investments. Investments, regardless of size, can conform to the strategic perspectives of previous orders, or comprise a new investment schema through the use of fractional investments and/or virtual shares. The reservoir can be replenished after executing one or more orders, so that it is more likely to have the desired investments for fulfilling future orders. Replenishment of the reservoir can be based on past order, or future expected orders, including an analysis of ordering trends and/or other investors' orders.

In embodiments of the invention based on fractional shares and allocation of shares of an investment to an investor's account, investments (or portions of an investment) are removed from the reservoir and allocated to a investor's account as their order is executed. This way the investor is the owner of that portion, and can exercise all ownership rights with respect to that portion. In other embodiments of the invention, a virtual share is allocated to the investor's account from the reservoir, and the entire investment remains in the reservoir. The investor is the owner for a time period. In effect, investors are only renting the benefits and liabilities of the asset. Overall management of the investment, including selling the investment when it reaches maturity or expiration rests with STAIR.

Embodiments of the invention also include just in time creation or ordering of investments. To execute an investors order, part or all or an investors order can be purchased just in time from an electronic network, marketplace, or other broker. In this way an investor's order can be executed without needing to maintain an overly large reservoir.

Embodiments of the invention also allow an investor to invest in assembled investments. For example, an investor could invest in a bond ladder that is assembled with short and long maturity bonds. The sub-assemblies for the bond ladder could come exclusively from the reservoir, exclusively from a just in time purchase, or a combination of the two. The assembly could also include pooling with other investor's funds or investments.

Embodiments of the invention assist the investor's strategic investments by allowing them to invest is predetermined portfolios of investments, or creating their own portfolio. An investor can create their own portfolio from scratch, or base it on a predetermined portfolio. An investor's portfolio can be a copy, or a modified copy, of another investor's portfolio.

Embodiments of the invention aggregate investor dollars, combining them with investment or seed capital provided by STAIR, and/or with various investment suppliers in the marketplace to either: a.) Take delivery of investment products. b). Maintain option contracts for the benefit of its investors, or c). Arranges for fractional and/or virtual interests in securities with various vendors. Embodiments of the invention use larger acquisition power to obtain best pricing for customers/members.

Embodiments of the invention include being implemented on a computer system. The computer system includes a bus or other communication mechanism for communicating information, and a processor coupled with the bus for processing information. The computer system also includes a main memory, such as a random access memory (RAM) or other dynamic storage device, coupled to the bus for storing information and instructions to be executed by the processor. Main memory also may be used for storing temporary variables or other intermediate information during execution of instructions to be executed by the processor. The computer system further includes a read only memory (ROM) or other static storage device coupled to the bus for storing static information and instructions for the processor. A storage device, such as a magnetic disk or optical disk, is provided and coupled to bus for storing information and instructions.

The computer system may be coupled via bus to a display, such as a cathode ray tube (CRT), for displaying information to a computer user. An input device, including alphanumeric and other keys, is coupled to the bus for communicating information and command selections to the processor. Another type of user input device is cursor control, such as a mouse, a trackball, or cursor direction keys for communicating direction information and command selections to the processor and for controlling cursor movement on display. This input device typically has two degrees of freedom in two axes, a first axis (e.g., x) and a second axis (e.g., y), that allows the device to specify positions in a plane.

The invention is related to the use of the computer system for managing investment portfolios with fractional and virtual shares. According to one embodiment of the invention, the STAIR system is provided by the computer system in response to the processor executing one or more sequences of one or more instructions contained in the main memory. Such instructions may be read into the main memory from another computer-readable medium, such as a storage device. Execution of the sequences of instructions contained in the main memory causes the processor to perform the process steps described herein. One or more processors in a multi-processing arrangement may also be employed to execute the sequences of instructions contained in the main memory. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to the processor for execution. Such a medium may take many forms, including but not limited to, non-volatile media, volatile media, and transmission media. Non-volatile media includes, for example, optical or magnetic disks, such as a storage device. Volatile media includes dynamic memory, such as main memory. Transmission media includes coaxial cables, copper wire and fiber optics, including the wires that comprise the bus. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to the processor for execution. For example, the instructions may initially be carried on a magnetic disk of a remote computer. The remote computer can load the instructions into its dynamic memory and send the instructions over a telephone line using a modem. A modem local to the computer system can receive the data on the telephone line and use an infra-red transmitter to convert the data to an infra-red signal. An infra-red detector coupled to the bus can receive the data carried in the infra-red signal and place the data on the bus. The bus carries the data to main memory, from which the processor retrieves and executes the instructions. The instructions received by the main memory may optionally be stored on the storage device either before or after execution by the processor.

The computer system also includes a communication interface coupled to the bus. The communication interface provides a two-way data communication coupling to a network link that is connected to a local network. For example, the communication interface may be an integrated services digital network (ISDN) card or a modem to provide a data communication connection to a corresponding type of telephone line. As another example, the communication interface may be a local area network (LAN) card to provide a data communication connection to a compatible LAN. Wireless links may also be implemented. In any such implementation, the communication interface sends and receives electrical, electromagnetic or optical signals that carry digital data streams representing various types of information.

The network link typically provides data communication through one or more networks to other data devices. For example, the network link may provide a connection through the local network to a host computer or to data equipment operated by an Internet Service Provider (ISP). The ISP in turn provides data communication services through the world wide packet data communication network now commonly referred to as the “Internet”. The local network and the Internet both use electrical, electromagnetic or optical signals that carry digital data streams. The signals through the various networks and the signals on the network link and through the communication interface, which carry the digital data to and from the computer system, are exemplary forms of carrier waves transporting the information.

The computer system can send messages and receive data, including program code, through the network(s), the network link and the communication interface. In the Internet example, a server might transmit a requested code for an application program through the Internet, the ISP, the local network and the communication interface. In accordance with the invention, one such downloaded application provides for STAIR as described herein.

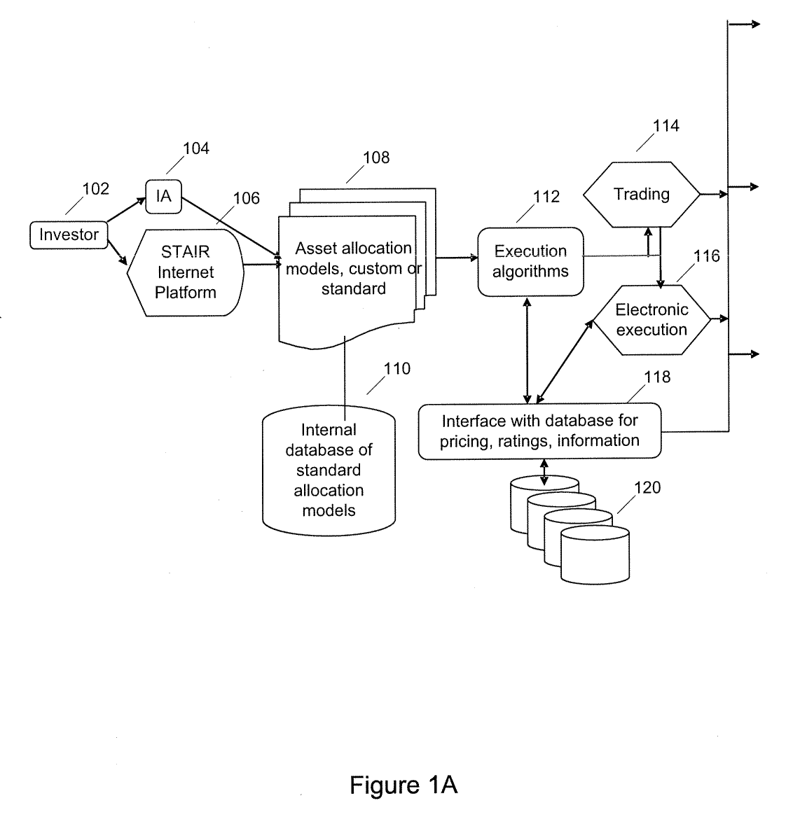

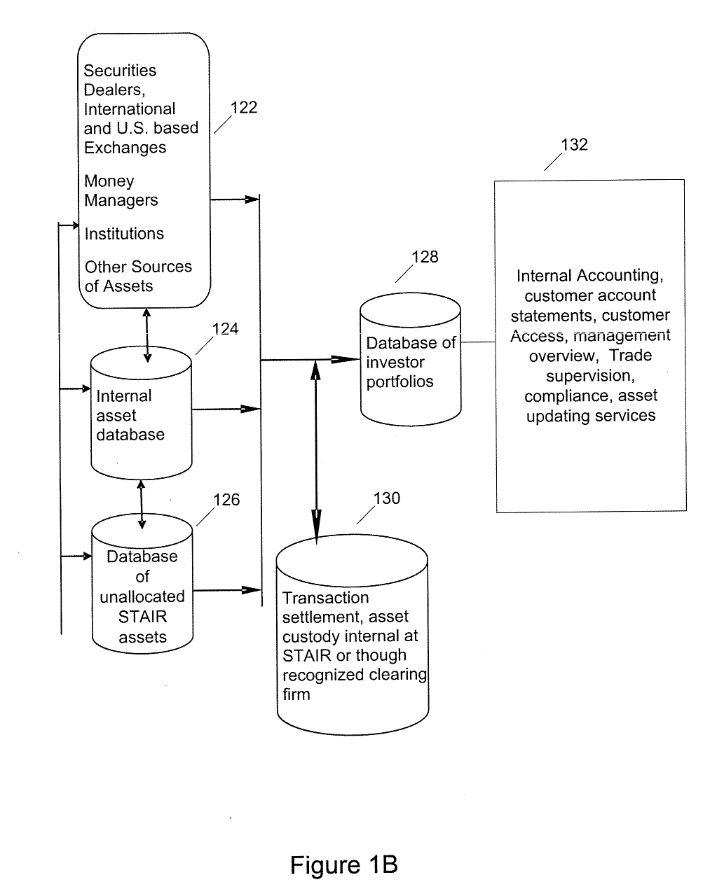

FIG. 1A is a block diagram showing the first part of the overall design of the STAIR system. It shows the overall design of the system, its components, and how they interact to execute an order.

The STAIR concept can be organized as a not-for-profit, or as a for profit entity such as, an LLC, a domestic or foreign corporation, bank, trust company, limited partnership, or credit union, etc. STAIR can also exist as an investment option within any organizational structure. For example STAIR products and services can be accessed as an investment option within mutual funds, Unit Investment Trusts (UITs), limited partnerships, hedge funds, managed accounts, trust accounts, and etc.

Some restrictions may apply to STAIR accounts. For example; redemptions/investments may be limited to once a quarter and some investor contributions may require several days or longer to be dispersed into the appropriate STAIR assets and portfolios. Unexecuted orders are assigned a pending status.

STAIR earns revenues by charging fees to STAIR investors. Fees earned by STAIR are calculated from a composite formula based on two main components; a). The value of the assets in the STAIR, or b). The types of investments held (for example an investor who owns only Money Market Funds in their STAIR account will be assessed lower fees, than one who owns Bond portfolios, Hedge funds, or Equities, etc.).

Investor 102 is a client of the STAIR system and can include natural persons, Mutual Funds, Trust Accounts, IRAs, Pension accounts, Hedge Funds, Credit Unions, Banks, or other entities and organizational structures domestic and foreign, and those organizational structures not yet envisioned or existing at the time of this application.

The investment advisor (IA) 104 can be a STAIR representative, or an investment advisor of the investor's own choosing, and assists the investor in developing and customizing their portfolio. The investment advisor can also provide investment and other financial advice.

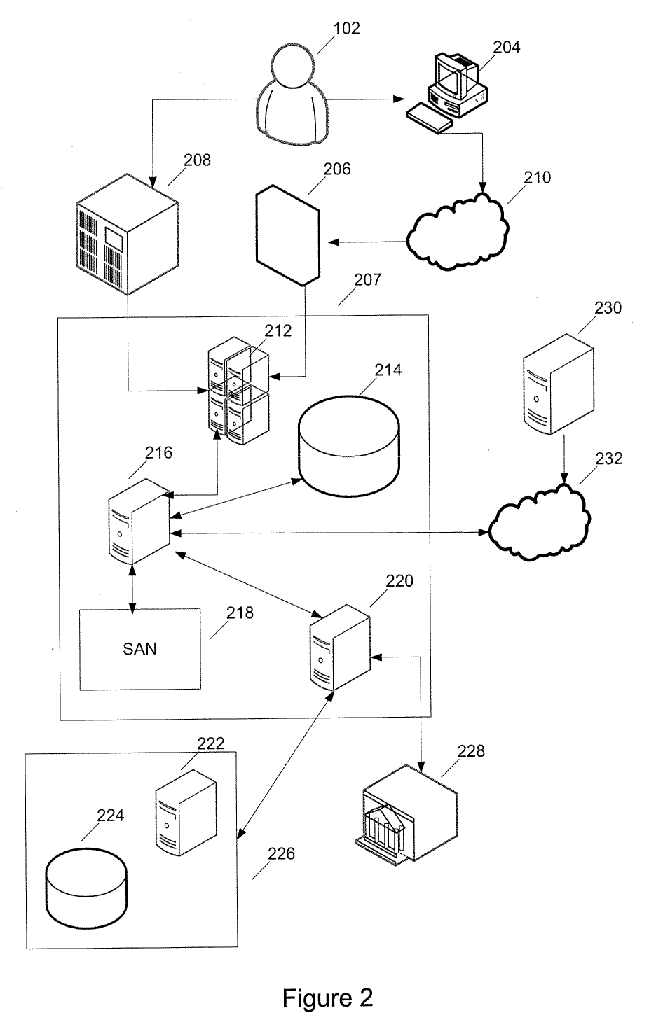

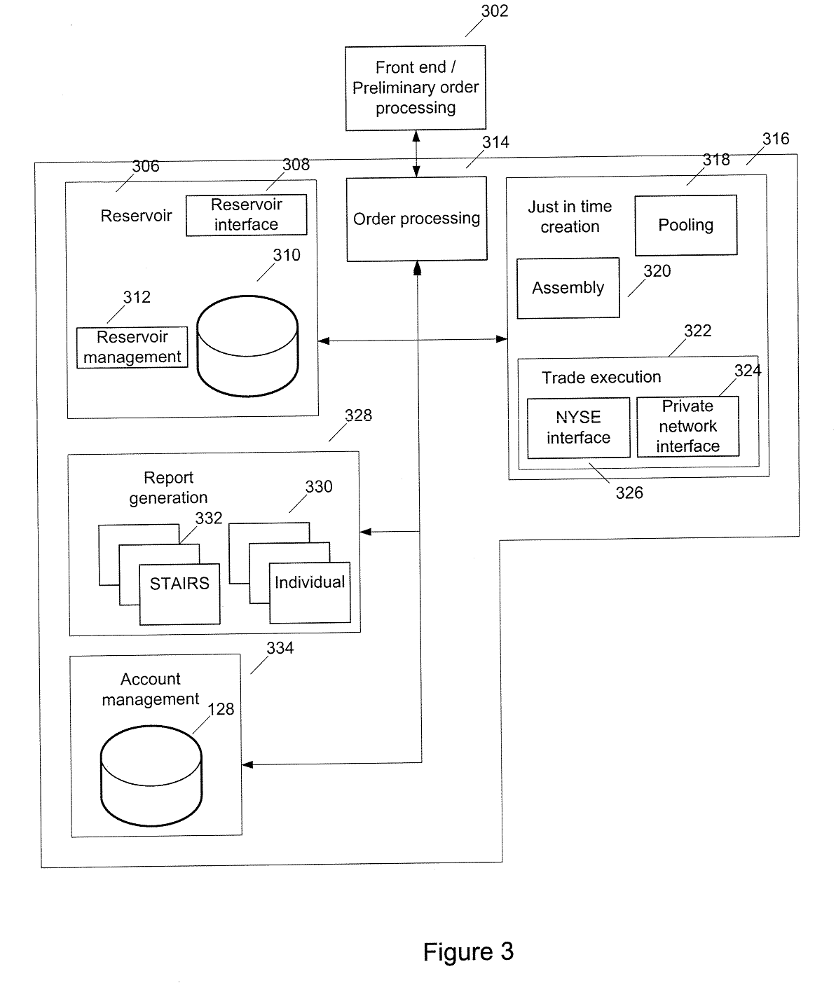

STAIR Internet platform 106 represents the hardware and software that makes the STAIR system available to investors over the Internet. Internet platform 106 allows investors to manage investments online, without needing a broker or investment advisor. The hardware and software design of STAIR and the STAIR Internet platform is described in further detail with respect to FIGS. 2 and 3.

Asset allocation models 108 and database of allocation models 110 represent allocation models that are available to the investor, and in which the investor can invest their funds. The allocation models include models predefined (i.e. standard) by STAIR, custom allocation models defined by the investor, and other investor's custom allocation models. Custom allocation models can be designed from scratch, or they can be based on an already existing allocation model.

For example, a predetermined allocation model may be directed to “high growth”, and include a number of small company stocks, a few large company stocks, and a small number of bonds. An investor could then modify this allocation model for their own preferences through the STAIR Internet platform 106, or in conjunction with an investment advisor. One example modification would be dropping one or more stocks, and allocating the investment funds proportionally to the remaining stocks.

Execution algorithms 112 are responsible for executing an investor's order. This includes interpreting an investor's order, and determining how the order can be fulfilled from investments in the reservoir and just in time purchases.

In further detail, STAIR maintains an inventory (a reservoir) of investment products, contracts, agreements, and access to investment vendors from which it acquires the building-block assets needed to prepare the virtual portfolios requested by its customers. The assets required to build a portfolio, if not already in the reservoir, may need to be acquired by STAIR. Similar in concept to “just in time” inventory management STAIR may rely on its cadre of investment vendors to create the assets as ordered by STAIR just in time for virtual delivery to a customer. The execution algorithms 112 can be designed to fulfill as much of an investors order through the reservoir as possible before attempting just in time purchases. Alternatively, the algorithms can be designed to purchase just in time as much as possible, before turning to the reservoir. Alternatively, an analysis can be done of how the investor can obtain the best prices for their investment.

When an order is placed with STAIR, either through the Internet web site, or through a customer's Financial Advisor, a computer program tracks the customer's order and matches it against available assets in the reservoir. STAIR computer systems continuously track and monitor the flows of investor funds and determine the amounts of new assets that need to be added into the reservoir. The STAIR computer systems also keep track of fulfillment orders placed by STAIR with outside vendors, and the balances of unallocated assets in the reservoir, as well as customer account balances.

For example, if STAIR had a $10,000,000 inventory of fixed maturity bonds in its reservoir, STAIR could virtually build, in advance or on demand, 3 distinct $2,000,000 portfolios. Each professionally prepared portfolio could be constructed to meet anticipated and/or actual investor objectives and risk profiles. STAIR could then sell fractional and virtual interests in each portfolio or a combination of portfolios, to investors. The individual assets are maintained by STAIR in the reservoir and fractional ownership interests are virtually assigned to the appropriate customer accounts. The fractional interest each investor owns in a portfolio entitles them to a pro rata share of the risks, rewards and proceeds when each bond in the portfolio matures.

The remaining $4,000,000 of bonds in the example above would remain in the reservoir as unassigned assets until fractional interests in their investment attributes (coupon, maturity, quality, etc.) are virtually allocated to an investor. Investors can use these unallocated bond assets to build their own custom portfolios. STAIR relies on a variety of computer algorithms for checks and balances, allocation of the proper fractional and virtual ownership of assets to the proper clients, and for the accounting for all unallocated assets.

The execution algorithms 112 also handle pooling an investor's order with other investors' orders to make larger or discounted purchases. A fractional or virtual share can be assigned to the investor from the larger purchase to fulfill their order. The execution algorithm can also handle assembling investments, such as bond ladders, from sub-assemblies and components.

Execution algorithms can obtain real-time price and availability information through database interface 118, which provides an interface to outside information sources, rating agencies, and electronic marketplaces. Based on this information, the execution algorithms can determine how to execute an investor's order, including whether to use the reservoir, or to make a just in time purchase.

Electronic execution 116 is the component in charge of interfacing with electronic stock, bond, or other marketplaces, for making just in time purchases. Electronic execution component 116 can also make purchases to replenish the reservoir. Trading system 114 is for trading with brokerages and other trading system that are not electronic.

FIG. 1B is a block diagram showing the second part of the overall design of the STAIRS system. Securities dealers 122, which also includes money managers, financial institutions and other sources of assets, is one external source for obtaining investments just in time. These sources can be accessed by the execution algorithms 112 through trading component 114 and electronic execution component 116.

Internal asset database 124 and database of unallocated STAIR assets 126 represent the reservoir, which holds investments available to fulfill investors' orders. Unallocated STAIR assets can includes stocks, bonds, a money market account, certificates of deposits, hedge fund accounts, either in whole, or as a fractional part for fulfilling investors' orders. These investments can be assigned or deposited in an investors account, so that they can exercise control over them including, receiving dividends, exercising corporate governance rights, and control the tax consequences of their investments. These investments can be assigned or deposited to an investors account much like a brokerage service. Alternatively, investors could be assigned a virtual share corresponding to their portion of ownership as described above.

In addition, the reservoir can contain an internal database 124 of assets that have only been partially assigned or deposited in an investor's account, but that are still available for fulfilling orders. An investor can receive a virtual share, proportional to their investment amount, in an investment that has a minimum purchase amount. For example, an investor could be allocated half of a $100,000 certificate of deposit for investing $50,000. The other half could remain unallocated in the internal asset database for allocation to another investor. Alternatively, such an investment could be fully allocated in response to pooling together of multiple investors' funds, and assigning of a one half virtual share to each investor. The investors could then share ownership and control rights with respect to the investment.

Database of investor portfolios 128 represents each investor's portfolio and is used to keep track of each investor's investments, including transaction, tax, and other financial information related to the investment. The customer's portfolio 128 can contain fractional and/or virtual shares of various investments. Fractional shares can be assigned or deposited into an investor's portfolio.

STAIR also maintains a database 130 of transaction information, including transaction settlement and asset custody information. This can be used for accounting purposes as related to STAIR. Alternatively, this information can be maintained by an outside clearing firm.

STAIR also maintains a database 132 of internal account information, customer account statements, management information, customer access records, trade supervision and compliance, and other administrative information. This information is used for reporting and interacting with customers, for example, providing monthly statements. This information can also be used for auditing and tax reporting on STAIR.

FIG. 2 is a block diagram showing the hardware design of STAIR. STAIR can be implemented in many different hardware technologies and can contain more or fewer components than shown in FIG. 2. Additional components can be added to increase reliability (e.g. hot failover systems), performance (e.g. server farms), and maintainability (e.g. management systems and interfaces).

An investor 102 is shown accessing STAIR 207 through client computer 204, the Internet 210, and firewall 206. Investor 102 is also shown accessing STAIR through phone exchange 208. Client computer 204 can be any desktop, notebook, or mobile device with networking capabilities. Client computer runs 204 runs an operating system, on which a client application, either standalone, or web based (e.g. a web browser) is used to access STAIR. A web based client/server interface for STAIR can be developed using standard technologies like HTML, JavaScript, and a web browser. The client interface can also be a phone based interface 208, which accesses STAIR 207 through the telephone network, and interacts with STAIR using either a live person or an automated system (e.g. an interactive voice response system).

Internet 210 can alternatively be any type of communication network capable of connecting clients to the server, for example, a WAN, a private network, or a wireless network. Firewall 206 can be used to enhance security and control access to STAIR 207.

The front-end applications forming the STAIR interface can be executed on a server 212. The server can be a rack mounted or multiprocessor server executing an operating system like Microsoft Windows or Linux. Server side applications can be developed using standard technologies. For a web based embodiment, standard multi-tier technologies including, Java, JavaScript, and HTML, can be used to develop the server side applications and interfaces to other systems and databases. Server 212 could be replaced with a server farm, or be connected to hot-failover systems to increase performance and availability of the STAIR system.

Server 212 is shown connected to a backend application server 216, that is connected to reservoir 214, storage area network 218, trading system 220, network 232, and information sources 230. Backend server can be a server similar to server 212, and is responsible for running algorithms to execute investors' orders. Backend server 212 also handles controlling trading with server 220, and collecting information from information sources. The algorithms and applications executing on server 216 can be written using standard technologies such a C++ and relational database interfaces.

Reservoir 214 is a database that stores investments that are available to fulfill orders. As orders are executed, investments can be removed from reservoir 214 and placed into investor portfolio database 128. Fractional shares of an investment can also be removed from the database by keeping track of what portion has been allocated to an investor and what portion has not been allocated. In this way reservoir 214 serves as an inventory of available investments.

Alternatively, in those embodiments of the invention where virtual shares are used, which may be in combination with allocation of whole or fractional shares of investments from reservoir, reservoir can maintain investments in the reservoir and allocate only virtual shares to investor portfolios that link back or refer to investments in the reservoir. The database supporting reservoir can be any known database technology, including relational databases.

Backend server 216 is also connected to network 232, which can be any type of communication network, including the Internet, and is used to access information sources for just in time purchases. Server 230 represents information such as quotes and quantities of available investments.

Trading server 220 can be similar to servers 212 and 216, and handles trades through electronic networks, or through a brokerage or other semi-automated trading network. The functionality of trading server 220, front-end server 212, and backend server 216, can be combined into one server or multiple servers, and FIG. 2 only represents one example design.

Trading server is shown connected to an electronic trading network 226, which is interfaced through a server 222 and contains database 224 of investments being traded in the network. Trading server is also shown connected to a non-electronic marketplace 228 where trades made finally be made by individuals.

FIG. 3 is a block diagram showing the software design of STAIR. STAIR is shown designed with a front end 302 component for supporting a graphical user interface and for processing orders. STAIR is also shown with a backend order processing component 314.

Front-end component 302 can be executed on front-end server 212, and in a client server web based embodiment, can handle delivering HTML pages and processing requests from the investor's web browser. The front end interface can be used by an investor to select or customize their portfolio, make allocations, view pending orders, and review monthly statements and other financial information. By separating front-end functionality from the backend order processing component 314, one or more front-ends can be designed and used, for example, to support mobile devices. Additionally, the front-end can be easily updated without major modifications to the other components of the system.

Front end component 302 can also handle order processing and interpretation before submitting the order to backend component 314 for execution. This way errors and other problems can be handled up front with a quick response to the investor using the system. Backend order processing component 314 is connected to a reservoir management component 306, just in time creation component 316, report generation component 328, and account management component 334.

Order processing component determines how to execute an investor's order, as described above. It uses information from reservoir component 306, and just in time creation component 316, and market information sources 120. Order processing component 314 is also in communication with information sources as described with respect to FIG. 2. Order processing component is able to communicate with other components through the interfaces they present. For example, reservoir component 306 has a reservoir interface 308 that can be used by the order processing component 314. By providing an interface between components, components of the system can be updated independently, as long as interfaces do not change.

Reservoir 306 contains a reservoir interface 308 for interacting with other components, and a database 310 contains investments that have been allocated or unallocated. As described above, the database also tracks if fractional or virtual shares have been allocated with respect to the investments in the database. Reservoir 306 also contains a reservoir management component 312 which handles replenishing reservoir with investments after fulfilling orders. This can be based on past or expected orders. It can also be based on predetermined inventory amounts.

Report generation component 328 is responsible for generating reports to investors for STAIR. For an individual, reports can consist of individual transaction reports, monthly statements, or annual year end statements. For STAIR, reports can be generated for auditing or tax purposes. Account management component manages investor portfolios in portfolio database 128. Updates between reservoir 306 and account management component 334 can be managed through order processing component 314.

Just in time component 316 handles purchasing and ordering investments to execute an investor's order. It can be used to fulfill an investor's order, either alone, or in combination with investments provided by reservoir component 306. Just in time component 316 includes a assembly component for assembling investments from sub-assemblies to fulfill an order. Just in time component also includes a pooling component 318 to pool other investors' funds before making purchases. Just in time component also includes a trade execution component 322 for executing actual trades to complete purchases.

Just in time creation component 320 handles creating investments and making the appropriate purchases. For example, if an investor orders a bond ladder, and the bond ladder (or the components of the bond ladder) were not available in the reservoir, the request would be made to the just in time component to purchase the bond ladder. The creation component would analyze the request, and determine the constituent parts that needed to be purchased to fulfill the order. As another example, if the order was for a particular stock, the creation component would not have to take any additional steps, and that request could be forwarded to trade execution module 322 for purchase.

Pooling component 318 handles pooling together of investor funds, or pooling together investments of funds from reservoir to make a purchase. By pooling together funds, discounts can be obtained. In addition, certain investments, for example, any requiring a million dollar minimum can be made by an investor who alone did not make an investment that large. Pooling component can match up similar investments made by different investors at the same time, or it can delay one investor's order execution until one or more other investors make similar investments sufficient to make a larger purchase.

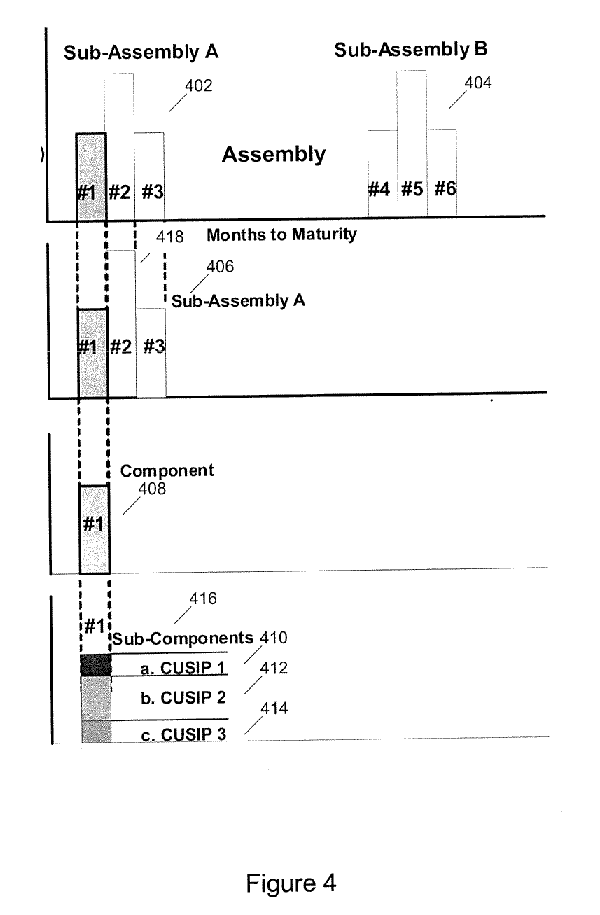

FIG. 4 is a diagram showing assembly of an investment from sub-components. As investment orders are received, each order is assigned a unique order number. Each order number refers to a specific client/member/customer name and their acct number; (i.e. Order #1213, Smith, acct #445. Each Order number consists of one or more Part Numbers. A Part number refers to an asset or a portfolio needed to fulfill the order. Each Part number has an investment algorithm associated with it. For example, a customer order number might read Order #1213, Smith, acct #445; And consists of investment Part Numbers 3994, 5858, 9239, and 2323. Part #3994 might be an investment in a designated ETF. Part #5858 might be an investment in a specific stock. Part #9239 might be an investment in an individual equity issue. Part #2323 might be an investment in a pre-configured bond ladder portfolio as follows:

A Taxable bond ladder, Investment grade, Barbell structure (approx 50% of the value is weighted in a short maturity cluster and approximately 50% is weighted in a longer maturity cluster), 7+-Year average life with clusters at 4 and 12 years (+-) and a gap of 5 years in which there are no bonds maturing.

The 2323 Investment Part Number algorithm is fulfilled by bringing together a variety of assemblies, sub-assemblies, components, and sub-components. An Assembly can be a single investment product (building-block), or a portfolio consisting of several building-blocks. A Sub-Assembly reflects the major Components that make up an Assembly. In this example there are two Sub-Assemblies (A, B) that make up Part 2323. Sub-Assemblies A, B in the illustration are composed of clusters of various bond CUSIPs. The cumulative par values (or $ values) in each maturity range are represented by the vertical cell. Sub-Assembly “A” has three maturity Components 408, 418, 406, as does Sub-Assembly “B”. Each Component in FIG. 4 is composed of several Sub-Components represented as different investment CUSIPs; a, b, and c.

More specifically, component 416 is shown being created from three different sub-components 410, 412, and 414, each of which has a unique CUSIP. These three smaller components 410, 412, and 414 form one component 408 of the overall investment. Similarly, a second 418 and third component 406 are combined together to form a first assembly 402 this process is repeated to create a second assembly 404. Together assemblies 402 and 404 form the overall ordered investment. Each component or subcomponent can be provided by the reservoir depending on what is available. Once the entire investment has been completed, it can be allocated to an investor portfolio, either in whole, fractionally, or virtually.

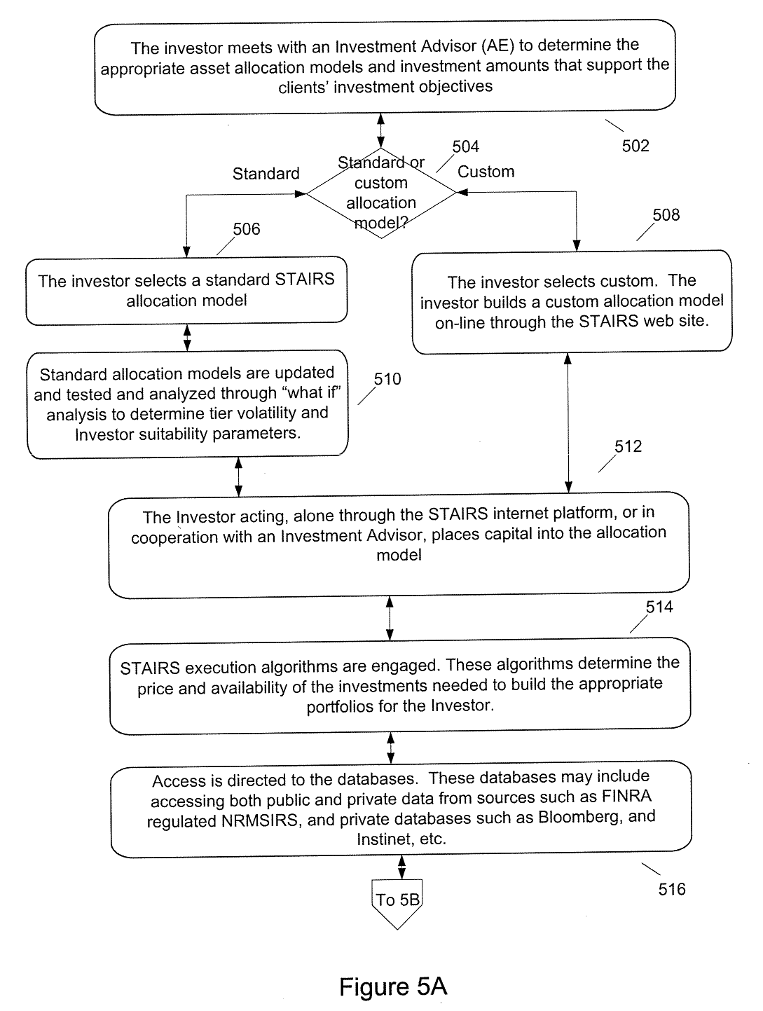

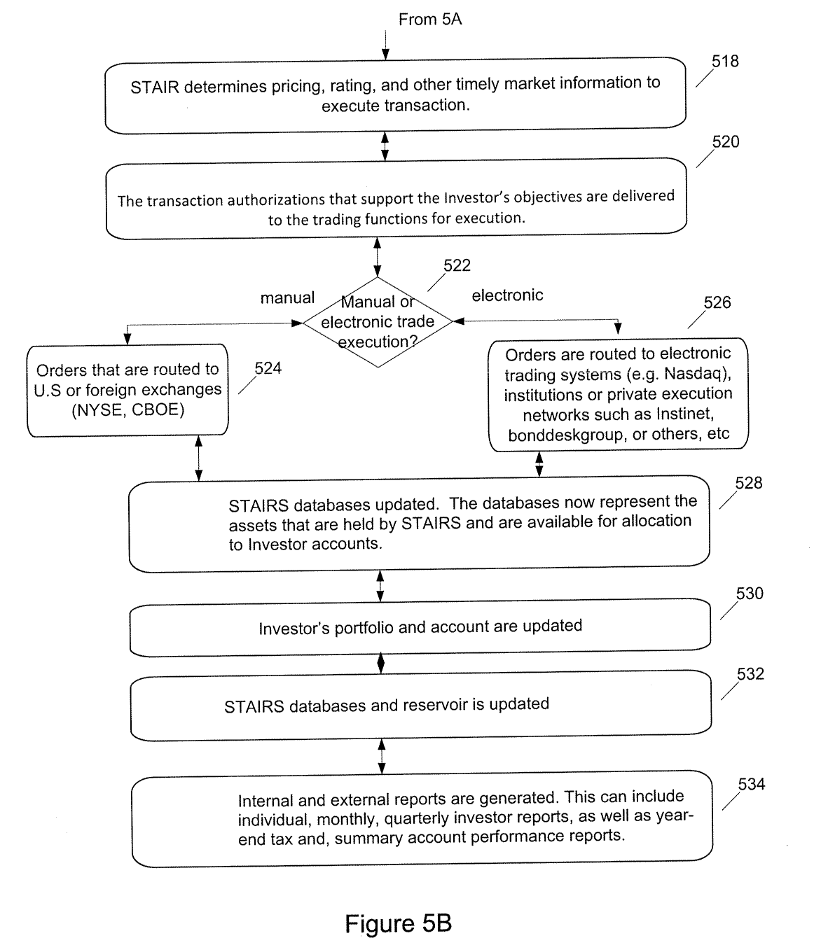

FIG. 5A is a flow diagram showing the first part of overall STAIRS investment process. FIGS. 5A and 5B, show the overall investment process for an investor from beginning to end. As an example, an investor/member who has $200,000 to invest in a STAIR account can, using the functionality available on the STAIR website, construct a personal asset allocation schema selecting from a number of standard portfolio representations illustrated on the STAIR website. Investors can also prepare a personal asset allocation schema using any building-block assets in the STAIR reservoir. (Note that subsequent contributions to the customer's STAIR account can be invested so as to follow the same or similar investment schema.)

The investor goes through the STAIR website making selections from lists of various portfolios and security assets to complete a personalized investment allocation consisting of the following items:

$100,000 in a Managed Money Account

$50,000 in a corporate bond portfolio (Baa rated, 8 year average duration, fixed maturities clustered around the 4 year and 11 year marks)

$25,000 in an Annuity

$5,000 in an Exchange Traded Fund (ETF)

$5,000 in a Hedge Fund

$10,000 in a Money Market Account

$2,500 in a Mutual Fund

$2,500 in Fractional Equity shares

The $100,000 placed into the Managed Money account is either pooled with other STAIR investors to meet the minimum investment amount required by the Money Manager or STAIR maintains a relationship with the Money Manager that, will accept STAIR's aggregated funds in any amount.

The bond portfolio is one of several constructed and maintained by STAIR to meet target objectives of; quality, duration, final maturity, maturity profiles (i.e. the years in which the various bonds reach their maturity), etc. If need be STAIR can go into the market place and acquire additional bonds or acquire options for the delivery of bonds or bond attributes to complete the ladder and fill the customer's order. The Annuity investment is made with an Annuity provider with whom STAIR has a relationship. The ETF investment is selected by the customer from those available in the marketplace. The $5,000 placed into the Hedge Fund is either pooled with other STAIR investors to meet the minimum investment amount required by the Hedge Fund or STAIR would seek to maintain relationships with the Hedge Funds that, will accept STAIR's aggregated investor funds in any amount. The $10,000 money market account can be selected by the customer from several money market funds available to STAIR investors. The $2,500 Mutual Fund can be selected from several Mutual Funds available to STAIR investors. $2500 into a stock may be made by way of external vendors who provide fractional equity share offerings to investors.

As another example, periodic investments can be made into a STAIR account. For example, an investor who would like to make monthly or other periodic deposits of $800 to a STAIR account. Similar to the lump sum contribution in the example above, the periodic investor can use the functionality of the STAIR website and, select and place funds into a number of STAIR prepared portfolios, or construct a custom portfolio from the building-block assets. The periodic investor receives the benefits of fractional and virtual interests in each of the assets of the portfolio. STAIR will disperse the proportion of the periodic investment dollars according to the design of the portfolio which could include:

$100 in a Managed Money Account

$150 in a corporate bond portfolio (Baa rated, 8 year average duration, fixed maturities that are clustered around the 4 year and 11 years mark)

$125 in an Annuity

$50 in an ETF

$175 in a Hedge Fund

$50 in a Money Market Account

$75 in a Mutual Fund

$75 into one or more Equities by way of external vendors who provide fractional share offerings to investors

Whether a single sum or periodic allotments are made to the STAIR account the investor receives the benefits and risks associated with each of their fractional and virtual investments. Subsequent contributions by the periodic investor can be allocated or dispersed in the same or similar proportional manner that supports the objectives of the investment schema.

In detail, at step 502 an investor meets with an investment advisor to determine the appropriate asset allocation model to meet their investment goals. Alternatively, an investor can determine this on their own. At step 504, the investor chooses whether to use a standard allocation model or custom allocation model. If the investor selects a standard allocation model at step 506, they are immediately ready to make an investment. At step 510, the system checks the standard model to ensure it is consistent with the goals for that model. Because of changing market conditions and other factors, a standard model may no longer achieve the goals it was originally designed to do. This check may be done periodically, randomly, at an investor's request, or at an administrator's request. This step does not need to be performed each time an investor selects a standard model.

At step 508, if the investor selects custom, they can begin customizing their allocation model. They can start from scratch, a standard model, or another investor's custom model. The investor can build their custom model using the graphical user interface of their client. For a web based embodiment, this may be a series of HTML pages rendered within a web browser through a series of text entry fields, drop down boxes, and other user interactive elements, an investor can select and assign the percentage of funds to be allocated to each type of investment. The server front-end processing 302 can support this by providing investment options from a database of available investments. It can also provide updated market and financial information to assist the investor's decision making process.

At step 512, the investor places capital into the allocation model. Capital can be provided from any source of funds the investor has, including a bank account and checks. These capital transfers can be done electronically through STAIR. Once the capital and the investor's order is received at step 514, the STAIR system executes its algorithms to execute the investor's order. As described above, STAIR uses investments from the reservoir, and purchases just in time investments to complete the investor's order. At step 516, STAIR accesses a number of databases to retrieve market information for decision making on how to execute an investor's order. These databases can also include databases for electronic trading networks to determine what investment are available, and the prices they are being sold at. For example, these databases and networks can include, FINRA regulated NRMSIRS, and private databases such as Bloomberg and Instinet.

FIG. 5B is a flow diagram showing the second part of the overall STAIRS investment process. At step 518, STAIR determines pricing, rating, and other timely marketing information to execute a transaction. At step 520, the transaction authorizations (e.g. buy a particular stock) that were determined based on the investor's order are delivered to the trade execution systems.

At step 522, STAIR determines if the trade execution is going to be manual (or semi-automated) or electronic. At step 524, manual execution orders are routed to trading system 114 (i.e. trade execution server 220 and trading market 228 for FIG. 2). At step 526, electronic trade orders are routed to electronic execution 116 for execution on an electronic network, such as NASDAQ, or institutions or private execution networks (i.e. trade execution server 220 and electronic network 226 of FIG. 2).

At step 528, after the trades have been completed and the necessary investments have been obtained, the STAIR databases are updated. This can include updating the reservoir database and corresponding investment tracking information. Other administrative and transaction databases can also be updated. Once the desired investments are in the reservoir, they can be allocated to an investor's portfolio. At step 530, the investor's portfolio and account are updated. At step 532, the reservoir and other STAIR databases are correspondingly updated. Finally, at step 534, reports of the transaction can be generated. This can include external reports for the investor, as well as internal reports for accounting and performance monitoring purposes.

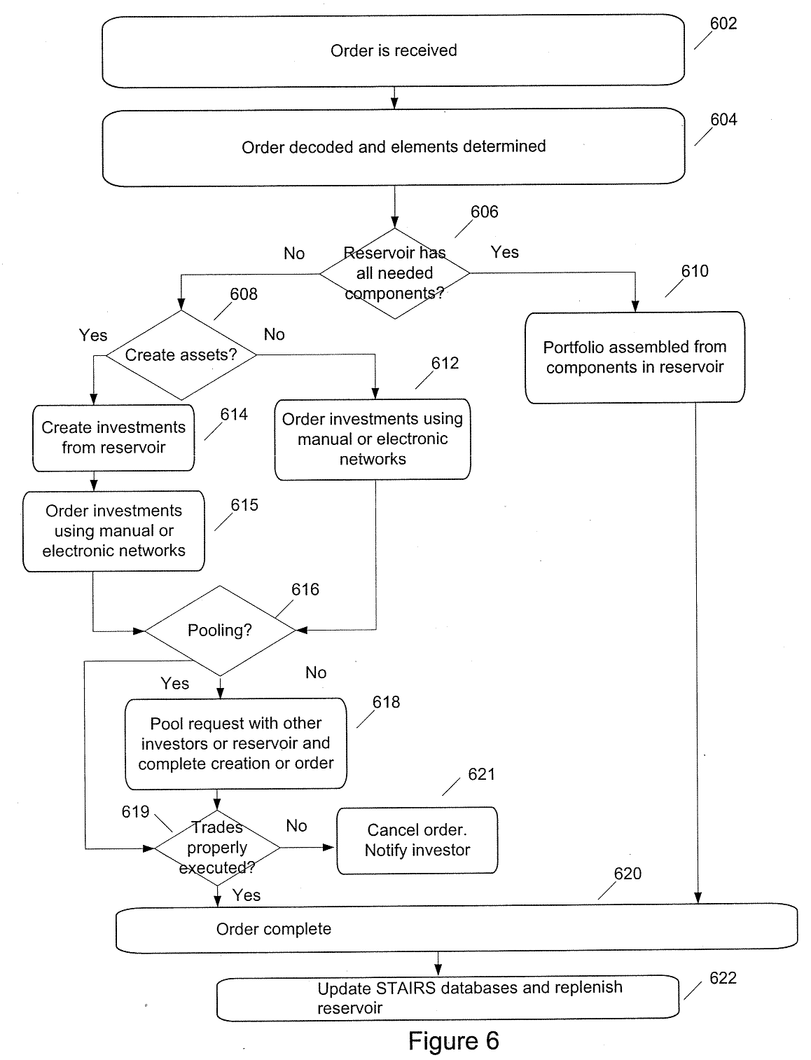

FIG. 6 is a flow diagram showing further details of the order processing. More specifically, FIG. 6 shows how the reservoir and just in time purchases can be used with pooling to execute an investor's order.

At step 602, an investor's order is received. It may contain multiple investments, including investments that need to be assembled. At step 604, the order is processed and decoded by preliminary order processing component 302. At step 606, STAIR determines if the reservoir contains all the necessary investments to execute the order. If so, then at step 610, the investor's order is executed from investments in the reservoir, and the investor's portfolio and the reservoir is updated. At step 620, the order is considered complete, and STAIR can update its database and replenish the reservoir if desired or necessary.

At step 606, if the reservoir does not have all the needed investments, then STAIR must purchase at least one investment just in time to complete the order. STAIR first determines at 608 if any investments need to be assembled to complete the order. If not, at step 612 the investments are purchased through an electronic or other marketplace. In addition, at step 616 it is determined if pooling is necessary or desired to purchase the investments in the investor's order. If so, then at step 618 the investor's funds are pooled with other investors' funds, or funds from the reservoir, and the investment is purchased.

At step 619, STAIR checks if the trades have been properly completed. For various reasons, including that an investment is no longer available (or available in the quantities desired), it may not be possible to complete the desired trade. At step 612, if a trade could not be completed, the investor is notified so that they can resubmit the order. Alternatively, the trading system (either manual or electronic) can be notified and can retry the trade either immediately or periodically. As another alternative, the entire order can be re-processed without intervention from the user. During reprocessing STAIR can choose a combination or investments and trades more likely to be executed. These retry and reprocessing steps can be performed anytime that a trade fails. At step 620, that portion of the order is completed. The process is repeated for the other investments in the investor's order.

At step 608, if STAIR determines that investments do need to be assembled, then the process begins at step 614 by selecting one or more components from the reservoir to assemble the investment. At step 615, the remaining (or all) investments needed to create the assembly are purchased in the same way as at step 612. At step 616, as above, it is determined if pooling is necessary, and the assembly is completed with the investments from the reservoir and the just in time purchases. At step 621 any trades that cannot be executed on the day the orders were placed are labeled as pending, and traders 114 and client account management system 128 are given the transaction status. At step 620, the order is considered completed. The process is repeated for the other investment in the investor's order that need to be assembled.

Other embodiments, extensions and modifications of the ideas presented above are comprehended and within the reach of one versed in the art upon reviewing the present disclosure. Accordingly, the scope of the present invention in its various aspects should not be limited by the examples and embodiments presented above. The individual aspects of the present invention and the entirety of the invention should be regarded so as to allow for such design modifications and future developments within the scope of the present disclosure. The present invention is limited only by the claims that follow.

What is claimed is:

1. A computer implemented method for investor directed allocation of funds among a plurality of investments comprising:
(a) a server receiving, from an investor using a client computer system and through an electronic network, an order allocating the investor's funds among a plurality of investments according to a predefined allocation plan;
(b) processing the order in an order processing system executing on the server, wherein the order processing system receives information from a reservoir of investments relating to what investments are in the reservoir, and wherein the reservoir is stored in a investment database accessible to the order processing system through an electronic network;
(c) executing the investor's order by:
(i) receiving, in response to a request by the order processing system for an investment needed to execute the investor's order, at least one investment from the reservoir of investment vehicles;
(ii) receiving at least one investment vehicle from a financial marketplace through a trading system coupled to the order processing system through an electronic network, wherein the investment vehicle is received in response to a request by the order processing system to purchase at least one investment not available in the reservoir, and wherein the request is made at the time the investor's order for allocating of funds is received; and
(iii) combining the investment received from the reservoir and the investment purchased from the financial marketplace to execute the investor's order;
(d) updating an account of the investor within the order processing system in response to the executed order;
(e) generating a report based on the processing of the order; and
(f) displaying to the investor, through a graphical user interface of the client computer system, the generated report.

2. The method of claim 1, wherein the reservoir can be automatically replenished by a reservoir management system after the order is executed.

3. The method of claim 2, wherein the reservoir is replenished based on the processed order and future expected orders.

4. The method of claim 1, wherein the investor's orders are periodically carried out without the need for trade-by-trade requests from the investor.

5. The method of claim 1, wherein at least a portion of the investor's funds are pooled with other funds to purchase the at least one investment vehicle.

6. The method of claim 5, wherein the other funds are from the reservoir.

7. The method of claims 1, wherein the predefined allocation plan is a standard allocation plan offered by the order processing system.

8. The method of claim 1, wherein prior to the order, the investor individually selects the investments for the allocation of the investor's funds using a graphical user interface on the client computer system, and wherein the graphical user interface comprises two windows, the first window showing the investor's current portfolio, and the second windows showing investments available to be included in the investor's portfolio.

9. The method of claim 1, wherein the reservoir contains virtual investment vehicles, and wherein a virtual share is allocated to the investor to execute their order.

10. The method of claim 1, wherein receiving, in response to a request by the order processing system for an investment needed to execute the investor's order, at least one investment from the reservoir of investment vehicles comprises: receiving a fractional portion of the investment, and wherein the reservoir tracks the unused portion of the investment.

11. The method of claim 10, wherein the unused portion of the investment is transferred to a second investor in response to an order from the second investor, wherein the investor and the second investor are distinct entities.

12. The method of claim 1, wherein the order allocates a least a portion of the investor's funds to an investment comprising a plurality of sub-components, and wherein the order processing system automatically fulfills the investor's order with respect to at least one sub-component in the same manner as fulfilling an order for an investment without sub-components.

13. The method of claim 1, where step (c) further comprises reprocessing the investors order when a trade necessary to complete the order cannot be completed.

14. A computer implemented system for investor directed allocation of funds among a plurality of investments comprising:
(a) a server receiving, from an investor using a client computer system and through an electronic network, an order allocating the investor's funds among a plurality of investments according to a predefined allocation plan;
(b) an order processing logic component for processing the order, wherein the order processing component receives information from a reservoir of investments relating to what investments are in the reservoir, and wherein the reservoir is stored in a investment database accessible to the order processing component through an electronic network;
(c) an execution component executing the investor's order by:
(i) receiving, in response to a request by the order processing system for an investment needed to execute the investor's order, at least one investment from the reservoir of investment vehicles;
(ii) receiving at least one investment vehicle from a financial marketplace through a trading system coupled to the order processing system through an electronic network, wherein the investment vehicle is received in response to a request by the order processing system to purchase at least one investment not available in the reservoir, and wherein the request is made at the time the investor's order for allocating of funds is received; and
(iii) combining the investment received from the reservoir and the investment purchased from the financial marketplace to execute the investor's order;
(d) updating an account of the investor within the order processing component in response to the executed order;
(e) generating a report based on the processing of the order; and
(f) displaying to the investor, through a graphical user interface of the client computer system, the generated report.

15. The system of claim 14, wherein the reservoir can be automatically replenished by a reservoir management system after the order is executed.

16. The system of claim 15, wherein the reservoir is replenished based on the processed order and future expected orders.

17. The system of claim 14, wherein the investor's orders are periodically carried out without the need for trade-by-trade requests from the investor.

18. The system of claim 14, wherein at least a portion of the investor's funds are pooled with other funds to purchase the at least one investment vehicle.

19. The system of claim 18, wherein the other funds are from the reservoir.

20. The system of claims 14, wherein the predefined allocation plan is a standard allocation plan offered by the order processing system.

21. The system of claim 14, wherein prior to the order, the investor individually selects the investments for the allocation of the investor's funds using a graphical user interface on the client computer system, and wherein the graphical user interface comprises two windows, the first window showing the investor's current portfolio, and the second windows showing investments available to be included in the investor's portfolio.

22. The system of claim 14, wherein the reservoir contains virtual investment vehicles, and wherein a virtual share is allocated to the investor to execute their order.

23. The system of claim 14, wherein receiving, in response to a request by the order processing system for an investment needed to execute the investor's order, at least one investment from the reservoir of investment vehicles comprises: receiving a fractional portion of the investment, and wherein the reservoir tracks the unused portion of the investment.

24. The system of claim 23, wherein the unused portion of the investment is transferred to a second investor in response to an order from the second investor, wherein the investor and the second investor are distinct entities.

25. The system of claim 14, wherein the order allocates a least a portion of the investor's funds to an investment comprising a plurality of sub-components, and wherein the order processing system automatically fulfills the investor's order with respect to at least one sub-component in the same manner as fulfilling an order for an investment without sub-components.

26. The system of claim 14, where step (c) further comprises reprocessing the investors order when a trade necessary to complete the order cannot be completed.

27. A computer-readable medium of instructions for investor directed allocation of funds among a plurality of investments comprising:
(a) receiving, from an investor using a client computer system and through an electronic network, an order allocating the investor's funds among a plurality of investments according to a predefined allocation plan;
(b) processing the order in an order processing component, wherein the order processing component receives information from a reservoir of investments relating to what investments are in the reservoir, and wherein the reservoir is stored in a investment database accessible to the order processing component through an electronic network;
(c) executing the investor's order by:
(i) receiving, in response to a request by the order processing component for an investment needed to execute the investor's order, at least one investment from the reservoir of investment vehicles;
(ii) receiving at least one investment vehicle from a financial marketplace through a trading component coupled to the order processing component through an electronic network, wherein the investment vehicle is received in response to a request by the order processing component to purchase at least one investment not available in the reservoir, and wherein the request is made at the time the investor's order for allocating of funds is received; and
(iii) combining the investment received from the reservoir and the investment purchased from the financial marketplace to execute the investor's order;
(d) updating an account of the investor in response to the executed order;
(e) generating a report based on the processing of the order; and
(f) displaying to the investor, through a graphical user interface of the client computer system, the generated report.

28. The computer-readable medium of instructions of claim 27, wherein the reservoir can be automatically replenished by a reservoir management component after the order is executed.

29. The computer-readable medium of instructions of claim 27, wherein the investor's orders are periodically carried out without the need for trade-by-trade requests from the investor.

30. The computer-readable medium of instructions of claim 27, wherein at least a portion of the investor's funds are pooled with other funds to purchase the at least one investment vehicle.

31. The computer-readable medium of instructions of claim 30, wherein the other funds are from the reservoir.

32. The computer-readable medium of instructions of claim 27, wherein prior to the order, the investor individually selects the investments for the allocation of the investor's funds using a graphical user interface on the client computer system, and wherein the graphical user interface comprises two windows, the first window showing the investor's current portfolio, and the second windows showing investments available to be included in the investor's portfolio.

33. The computer-readable medium of instructions of claim 27, wherein the reservoir contains virtual investment vehicles, and wherein a virtual share is allocated to the investor to execute their order.

34. The computer-readable medium of instructions of claim 27, wherein receiving, in response to a request by the order processing system for an investment needed to execute the investor's order, at least one investment from the reservoir of investment vehicles comprises: receiving a fractional portion of the investment, and wherein the reservoir tracks the unused portion of the investment.

35. The computer-readable medium of instructions of claim 27, wherein the order allocates a least a portion of the investor's funds to an investment comprising a plurality of sub-components, and wherein the order processing system automatically fulfills the investor's order with respect to at least one sub-component in the same manner as fulfilling an order for an investment without sub-components.
